(19) United States
(12) Patent Application Publication
(10) Pub. No.: US 2011/0278507 A1
(43) Pub. Date: Nov. 17, 2011

(54) THICK FILM SILVER PASTES CONTAINING IODONIUM AND/OR SULFONIUM SALTS AND THEIR USE IN PHOTOVOLTAIC CELLS

(75) Inventors: Angel R. Cartagena, Apex, NC (US); Haixin Yang, Chapel Hill, NC (US)

(73) Assignee: E. I. DU PONT DE NEMOURS AND COMPANY, Wilmington, DE (US)

(21) Appl. No.: 12/777,589

(22) Filed: May 11, 2010

(51) Int. Cl. H01B 1/22

(52) U.S. Cl. 252/514

(57) ABSTRACT

This invention provides a silver thick film paste composition comprising electrically conductive silver powder, one or more onium salts selected from the group consisting of iodonium salts and sulfonium, flux and an organic medium. Also provided are photovoltaic cells that contain an electrode made using these silver thick film paste compositions. Such photovoltaic cells show improved efficiencies.

### FIELD OF THE INVENTION

This invention is directed to thick film silver paste compositions containing iodonium and/or sulfonium salts. These compositions are particularly useful in forming solar cell electrodes that result in improved solar cell performance.

### TECHNICAL BACKGROUND OF THE INVENTION

Silver powder is used in the electronics industry for the manufacture of conductor thick film pastes. The thick film pastes are screen printed onto substrates forming conductive elements. These elements are then dried and fired to volatilize the liquid organic medium and sinter the silver particles.

The silver thick film paste compositions of the present invention can be applied to a broad range of semiconductor devices, although it is especially effective in light-receiving elements such as photovoltaic cells and, in particular solar cells. The background of the invention is described below with reference to solar cells as a specific example of the prior art.

A conventional solar cell structure with a p-type base has a negative electrode that is typically on the front side, i.e., sun side or illuminated side, of the cell and a positive electrode on the back side. Radiation of an appropriate wavelength falling on a p-n junction of a semiconductor device serves as a source of external energy to generate hole-electron pairs in that device. Because of the potential difference which exists at a p-n junction, holes and electrons move across the junction in opposite directions and thereby give rise to the flow of an electric current that is capable of delivering power to an external circuit. Most solar cells are in the form of a silicon wafer that has been metalized, i.e., provided with metal contacts that are electrically conductive.

Most electric power-generating solar cells currently used are silicon solar cells. Process flow in mass production is generally aimed at achieving maximum simplification and minimizing manufacturing costs. Electrodes in particular are made by using a method such as screen printing a metal paste and subsequent firing.

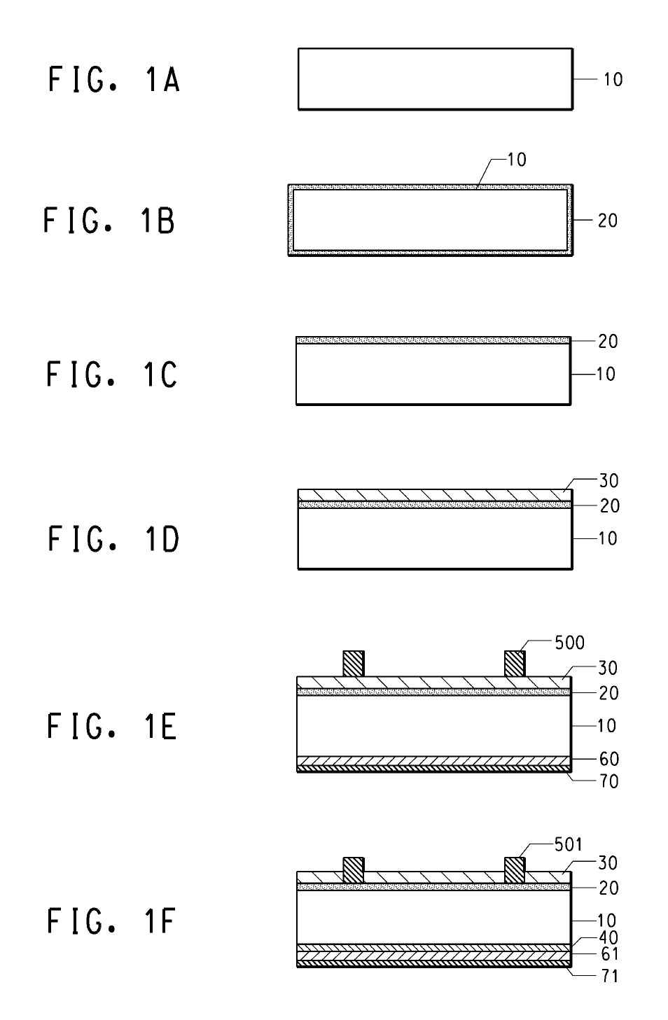

An example of this method of production is described below in conjunction with FIG. 1. FIG. 1A shows a p-type silicon substrate, 10.

In FIG. 1B, an n-type diffusion layer, 20, of the reverse conductivity type is formed by the thermal diffusion of phosphorus (P) or the like. Phosphorus oxychloride (POCl₃) is commonly used as the phosphorus diffusion source. In the absence of any particular modification, the diffusion layer, 20, is formed over the entire surface of the silicon substrate, 10. This diffusion layer has a sheet resistivity on the order of several tens of ohms per square (Ω/μ), and a thickness of about 0.3 to 0.5 μm.

After protecting one surface of this diffusion layer with a resist or the like, as shown in FIG. 1C, the diffusion layer, 20, is removed from most surfaces by etching so that it remains only on one main surface, in this case the front side. The resist is then removed using an organic solvent or the like.

Next, a silicon nitride (Si₃N₄) film, 30, is formed as an anti-reflection coating (ARC) on the n-type diffusion layer, 20, to a thickness of about 70 nm to 90 nm in the manner shown in FIG. 1D by a process such as plasma chemical vapor deposition (CVD).

As shown in FIG. 1E, a silver paste, 500, for the front electrode is screen printed then dried over the silicon nitride film, 30. In addition, an aluminum paste, 60, and a back side silver or silver/aluminum paste, 70, are then screen printed and successively dried on the back side of the substrate. Firing is then typically carried out in an infrared furnace at a temperature range of approximately 700° C. to 975° C. for a period of from several minutes to several tens of minutes.

Consequently, as shown in FIG. 1F, aluminum diffuses from the aluminum paste into the silicon substrate, 10, as a dopant during firing, forming a p+ layer, 40, containing a high concentration of aluminum dopant. This layer is generally called the back surface field (BSF) layer, and helps to improve the energy conversion efficiency of the solar cell.

The aluminum paste is transformed by firing from a dried state, 60, to an aluminum back electrode, 61. The back side silver or silver/aluminum paste, 70, is fired at the same time, becoming a silver or silver/aluminum back electrode, 71. During firing, the boundary between the back side aluminum electrode and the back side silver or silver/aluminum electrode assumes an alloy state, and is connected electrically as well. The aluminum electrode accounts for most areas of the back electrode, owing in part to the need to form a p+ layer, 40. Because soldering to an aluminum electrode is impossible, a silver back electrode is formed over portions of the back side as an electrode for interconnecting solar cells by means of copper ribbon or the like.

In addition, during firing, the front electrode-forming silver paste, 500, sinters and penetrates through the silicon nitride film, 30, and is thereby able to electrically contact the n-type layer, 20. This type of process is generally called “fire through.” This fired through state is apparent in layer 501 of FIG. 1F.

There is a need for a thick film paste composition suitable for use as an electrode for semiconductor devices and particularly as the front electrode on the front side of a solar cell that results in a solar cell with higher efficiency.

### SUMMARY OF THE INVENTION

This invention provides a silver thick film paste composition comprising:
a) electrically conductive silver powder;
b) one or more onium salts selected from the group consisting of iodonium salts and sulfonium salts;
c) flux selected from the group consisting of glass frit, ZnO, Zn, compounds that can form ZnO upon firing and mixtures thereof; and
d) an organic medium, wherein the silver powder, the one or more onium salts and the flux are dispersed in the organic medium.

In one embodiment the iodonium salts are diaryl iodonium salts. In another embodiment the sulfonium salts are triaryl sulfonium salts.

In addition, there is provided a semiconductor device, and in particular a photovoltaic cell, comprising an electrode that, prior to firing, comprises one the silver thick film paste compositions described above.

The silver thick film paste compositions of the invention enable the production of high quality semiconductor devices. In particular, they enable the production of higher efficiency solar cells.

### BRIEF DESCRIPTION OF THE FIGURES

FIG. 1 is a process flow diagram illustrating the fabrication of a semiconductor device. Reference numerals shown in FIG. 1 are explained below:
10: p-type silicon substrate
20: n-type diffusion layer
30: silicon nitride film, titanium oxide film, or silicon oxide film
40: p+ layer (back surface field, BSF)
60: aluminum paste formed on back side
61: aluminum back electrode obtained by firing back side aluminum paste 60
70: silver or silver/aluminum paste formed on back side
71: silver or silver/aluminum back electrode obtained by firing back side silver paste
500: silver paste formed on front side
501: silver front electrode obtained by firing front side silver paste 500

### DETAILED DESCRIPTION OF THE INVENTION

This invention provides a silver thick film paste composition comprised of electrically conductive silver powder, onium salts and flux, all dispersed in an organic medium. The thick film composition includes the silver powder functional phase that imparts appropriate electrically functional properties to the composition. The silver thick film paste composition also includes one or more onium salts selected from the group consisting of iodonium salts and sulfonium salts and flux selected from the group consisting of glass frit, ZnO, Zn, compounds that can form ZnO upon firing and mixtures thereof. The silver powder, iodonium salt and flux are all dispersed in the organic medium that acts as a carrier. The composition is fired to burn out the organic medium, activate the flux phase and to impart the electrically functional properties.

In one embodiment the flux is glass frit. In another embodiment the flux is ZnO. In still another embodiment the flux is a mixture of glass frit and ZnO.

As used herein, “thick film paste composition” refers to a composition which after being deposited on a substrate and fired has a thickness of 1 to 100 μm.

### Silver Powder

The particle size of the silver in the silver powder is not subject to any particular limitation. In one embodiment, the average particle size of the silver is less than 10 microns; in a further embodiment, the average particle size of the silver is less than 5 microns. In one embodiment, the silver thick film paste composition comprises from 70 to 95 wt % silver powder based on the total weight of the silver thick film paste composition; in an aspect of this embodiment, the silver thick film paste composition comprises from 80 to 90 wt % silver powder based on the total weight of the silver thick film paste composition.

The silver particles in the silver powder of the composition may be coated or uncoated silver particles which are electrically conductive. In an embodiment in which the silver particles are coated, they are at least partially coated with a surfactant. The surfactant may be selected from, but is not limited to, stearic acid, palmitic acid, a salt of stearate, a salt of palmitate and mixtures thereof. Other surfactants may be utilized including lauric acid, palmitic acid, oleic acid, stearic acid, capric acid, myristic acid and linolic acid. The counter-ion can be, but is not limited to, hydrogen, phosphate, ammonium, sodium, potassium and mixtures thereof.

### Onium Salts

The onium salts are selected from the group consisting of iodonium salts and sulfonium salts. In some embodiments of the composition the iodonium salts are diaryl iodonium salts with the structure I

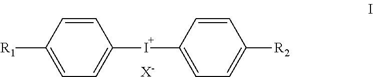

and the sulfonium salts are triaryl sulfonium salts with the structure II

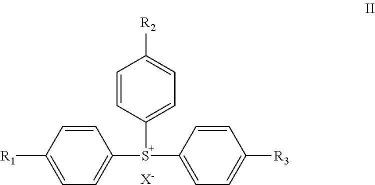

wherein, in both structures, for example, X═SbF₆, PF₆, BPh₄, CF₃SO₃, or (CF₃SO₂)₃C and R₁, R₂ and R₃ are independently H, an alkyl group or an aryl group.

Specific, but non-limiting, examples of useful iodonium and sulfonium salts are bis(4-tert-butylphenyl)iodonium hexafluorophosphate, bis(4-tert-butylphenyl)iodonium hexafluoroantimonate, bis(4-tert-butylphenyl)iodonium triflate, bis(4-tert-butylphenyl)iodonium camphorsulfonate, bis(4-tert-butylphenyl)iodonium tosylate, [4-(octyloxy)phenyl]phenyl iodonium hexafluorophosphate, [4-(octyloxy)phenyl]phenyl iodonium hexafluoroantimonate, triphenyl sulfonium hexafluoroantimonate, triphenyl hexafluorophosphate, UVACURE® 1600 (phenyl-p-octyloxyphenyl-iodonium hexafluoroantimonate obtained from Cytec Industries, Smyrna, Ga.), Ciba®Irgacure® 250 (a 75% solution of iodonium, (4-methylphenyl)[4-(2 methylpropyl)phenyl]heaxafluorophosphate in propylene carbonate obtained from Ciba Specialty Chemicals, BASF) and triphenylsulfonium perfluoro-1-butane sulfonate (TPS-nf).

The onium salts are stable at typical storage temperatures. A few parts per million of a stabilizer can prevent pre-mature decomposition of onium salts

In one embodiment the silver thick film paste composition comprises from 0.5 to 15 wt % of the one or more onium salts based on the total weight of the silver thick film paste composition. In another embodiment the silver thick film paste composition comprises from 1 to 5 wt % of the one or more onium salts based on the total weight of the silver thick film paste composition. In still another embodiment the silver thick film paste composition comprises from 1.5 to 2.5 wt % of the one or more onium salts based on the total weight of the silver thick film paste composition.

### Flux

The flux is selected from the group consisting of glass frit, ZnO, Zn, compounds that can form ZnO upon firing and mixtures thereof.

The glass frit is described herein as percentages of its constituents. The percentages are the percentages of the constituents used in the starting material that is subsequently processed as described herein to form a glass composition. The glass frit contains certain constituents and the weight percentages of those constituents are expressed as a weight percentage of the corresponding oxide or fluoride form. The weight percentages of the glass frit constituents are based on the total weight of the glass frit. Ranges of the wt % of the constituents are indicated. A certain portion of volatile species may be released during the process of making the glass. An example of a volatile species is oxygen.

Various glass frits are useful in the silver thick film paste compositions of the invention. The glass frit used has a softening point of 300 to 600° C. The glass fits described herein are not limiting. Minor substitutions of additional ingredients can be made without substantially changing the desired properties of the glass frit. For example, substitutions of glass formers such as 0-5 wt % P₂O₅, 0-5 wt % GeO₂ and 0-5 wt % V₂O₅ can be used either individually or in combination to achieve similar performance.

The glass fits can also contain one or more fluorine-containing constituents such as salts of fluorine, fluorides and metal oxyfluoride compounds. Such fluorine-containing constituents include, but are not limited to BiF₃, AlF₃, NaF, LiF, KF, CsF, PbF₂, ZrF₄, TiF₄ and ZnF₂.

It has been observed that the inclusion of PbF₂ as a glass frit constituent, i.e., the addition of fluorine as an anionic substitution for oxygen in a Pb containing glass, imparts a particular advantage in photovoltaic cell performance. The fluorine can be added by using any of a number of raw material fluoride salts as can be seen by one skilled in the art of glass making. The specific advantage provided by the fluorine substitution is the progressive development of immiscibility in the glass as increasing amounts of fluorine are introduced to the glass composition. Two liquid phases may be created at elevated temperature in many cases characterized by a siliceous more refractory glass phase and a soft glass phase characterized as generally containing lead oxide, boric oxide and fluoride salts. A secondary advantage is the progressive shift to a lower temperature onset of sintering as evidenced by TMA measurements of the glass as fluorine is substituted for oxygen. This development of glass immiscibility can advantageously change the chemical activity of the molten glass in a dynamic fashion with time from its initial fusion and reaction conditions, necessary to remove the insulating layer on device structures, to a less active state while providing for the adhesion of metallic conductor materials formulated with the glass to affect a bond adhesion and electrical contact to the semiconductor substrate. The soft glass phase tends to be encapsulated by the siliceous glass phase as the soft glass coalesces from small droplets to larger droplets resulting in potential property changes in the glass that have specific advantages to the performance properties of a solar cell made with such materials. The thermal process latitude of the cell efficiency and other performance properties may be extended over a broader temperature range than of materials made with non-immiscible glass or non-crystallizable glass used in the conductor paste formulation on a suitable semiconductor substrate. Alternative metal fluoride salts include, but are not limited to, PbF₂, BiF₃, AlF₃, NaF, LiF, and/or ZnF₂.

Exemplary lead containing glass frits comprise the following oxide constituents in the range of 0-36 wt % SiO₂, 0-9 wt % Al₂O₃, 0-19 wt % B₂O₃, 16-84 wt % PbO, 0-4 wt % CuO, 0-24 wt % ZnO, 0-52 wt % Bi₂O₃, 0-8 wt % ZrO₂, 0-20 wt % TiO₂, 0-5 wt % P₂O₅, and 3-34 wt % PbF₂. In other embodiments relating to glass frits containing bismuth oxide, the glass frit contains 4-26 wt % SiO₂, 0-1 wt % Al₂O₃, 0-8 wt % B₂O₃, 20-52 wt % PbO, 0-4 wt % ZnO, 6-52 wt % Bi₂O₃, 2-7 wt % TiO₂, 5-29 wt % PbF₂, 0-1 wt % Na₂O and 0-1 wt % Li₂O. In still other embodiments relating to glass frit containing 15-25 wt % ZnO, the glass frit comprises 5-36 wt % SiO₂, 0-9 wt % Al₂O₃, 0-19 wt % B₂O₃, 17-64 wt % PbO, 0-39 wt % Bi₂O₃, 0-6 wt % TiO₂, 0-5 wt % P₂O₅ and 6-29 wt % PbF₂. In various of these embodiments containing ZnO, the glass frits comprises 5-15 wt % SiO₂ and/or 20-29 wt % PbF₂ and/or 0-3 wt % ZrO₂ or 0.1-2.5 wt % ZrO₂. Embodiments containing copper oxide and/or alkali modifiers comprise 25-35 wt % SiO₂, 0-4 wt % Al₂O₃, 3-19 wt % B₂O₃, 17-52 wt % PbO, 0-12 wt % ZnO, 0-7 wt % Bi₂O₃, 0-5 wt % TiO₂, 7-22 wt % PbF₂, 0-3 wt % CuO, 0-4 wt % Na₂O and 0-1 wt % Li₂O.

Exemplary lead free glass frits contain one or more of SiO₂, B₂O₃, Al₂O₃, Bi₂O₃, BiF₃, ZnO, ZrO₂, CuO, Na₂O, NaF, Li₂O, LiF, K₂O, and KF. In various embodiments the glass frits comprise the following oxide constituents in the ranges, 17-26 wt % SiO₂, 2-9 wt % B₂O₃, 0.1-5 wt % Al₂O₃, 0-65 wt % Bi₂O₃, 0-67 wt % BiF₃, 0-5 wt % ZrO₂, 1-7 wt % TiO₂, 0-3 wt % CuO, 0-2 wt % Na₂O, 0-3 wt % NaF, 0-2 wt % Li₂O, and 0-3 wt % LiF. Some or all of the Na₂O or Li₂O can be replaced with K₂O and some or all of the NaF or LiF can be replaced with KF to create a glass with properties similar to those listed above.

The particular choice of raw materials can unintentionally include impurities that may be incorporated into the glass during processing. For example, the impurities may be present in the range of hundreds to thousands ppm. The presence of such impurities would not alter the properties of the glass, the silver thick film paste composition, or the fired device. For example, a solar cell containing the silver thick film paste composition can have the efficiencies described herein, even if the silver thick film paste composition includes impurities.

In one embodiment, the average particle size of the glass frit is in the range of 0.5-1.5 μm; in a further embodiment, the average particle size is in the range of 0.8-1.2 μm. In one embodiment, the silver thick film paste composition comprises from 0.5 to 4 wt. % glass frit based on the total weight of the silver thick film paste composition. In another embodiment, the silver thick film paste composition comprises from 1 to 3 wt % glass frit based on the total weight of the silver thick film paste composition. In a further embodiment, the silver thick film paste composition comprises from 1.5 to 2.5 wt % glass frit based on the total weight of the silver thick film paste composition.

An exemplary method for producing the glass frits described herein is by conventional glass making techniques. Ingredients are weighed then mixed in the desired proportions and heated in a furnace to form a melt in platinum alloy crucibles or other suitable metal or ceramic crucibles. As indicated above, oxides as well as fluoride or oxyfluoride salts can be used as raw materials. Alternatively, salts, such as nitrate, nitrites, carbonate, or hydrates, which decompose into oxide, fluorides, or oxyfluorides at temperature below the glass melting temperature can be used as raw materials. Heating is conducted to a peak temperature of typically 800-1400° C. and for a time such that the melt becomes entirely liquid, homogeneous, and free of any residual decomposition products of the raw materials. The molten glass is then quenched between counter rotating stainless steel rollers to form a 10-15 mil thick platelet of glass. The resulting glass platelet was then milled to form a glass frit powder with its 50% volume distribution set between to a desired target (e.g. 0.8-1.5 μm). Alternative synthesis techniques such as water quenching, sol-gel, spray pyrolysis, or others appropriate for making powder forms of glass can be employed.

A zinc-containing flux is selected from ZnO, Zn or any compounds that can form ZnO upon firing.

In one embodiment, the Zn-containing additive is ZnO, wherein the ZnO has an average particle size in the range of 10 nanometers to 10 microns. In a further embodiment, the ZnO has an average particle size of 40 nanometers to 5 microns. In still a further embodiment, the ZnO has an average particle size of 60 nanometers to 3 microns.

In one embodiment, the silver thick film paste composition comprises from 2 to 10 wt. % ZnO based on the total weight of the silver thick film paste composition. In another embodiment, the silver thick film paste composition comprises from 3 to 8 wt. % ZnO based on the total weight of the silver thick film paste composition. In still a further embodiment, the silver thick film paste composition comprises from 5 to 7 wt. % ZnO based on the total weight of the silver thick film paste composition

In a further embodiment the silver thick film paste composition comprises a compound that can form ZnO upon firing. In one such embodiment, the silver thick film paste composition comprises from 2 to 16 wt. % of such a compound based on the total weight of the silver thick film paste composition. In another such embodiment, the silver thick film paste composition comprises from 4 to 12 wt. % of such a compound based on the total weight of the silver thick film paste composition.

### Organic Medium

The silver powder, the one or more onium salts and the flux are dispersed in an organic medium by mechanical mixing to form viscous compositions called “pastes”, having suitable consistency and rheology for printing. The organic medium may include a wide variety of inert viscous materials. The organic medium is one in which the flux is dispersible with an adequate degree of stability. The rheological properties of the medium may lend good application properties to the composition, including: stable dispersion of solids, appropriate viscosity and thixotropy for screen printing, appropriate wet ability of the substrate and the paste solids, a good drying rate, and good firing properties.

In one embodiment, the organic medium used in the thick film composition of the present invention is a non-aqueous inert liquid. The use of various organic media, which may or may not contain thickeners, stabilizers and/or other common additives, is contemplated. The organic medium may be a solution of polymer(s) in solvent(s). In an embodiment, the polymer may be ethyl cellulose. Other exemplary polymers include ethylhydroxyethyl cellulose, wood rosin, mixtures of ethyl cellulose and phenolic resins, polymethacrylates of lower alcohols, and monobutyl ether of ethylene glycol monoacetate, or mixtures thereof. In an embodiment, the solvents useful in thick film compositions described herein include ester alcohols and terpenes such as alpha- or beta-terpineol or mixtures thereof with other solvents such as kerosene, dibutylphthalate, butyl carbitol, butyl carbitol acetate, hexylene glycol and high boiling alcohols and alcohol esters. In addition, the organic vehicle may include volatile liquids for promoting rapid hardening after application on the substrate. In one embodiment, the organic medium may also include one or more surfactants.

In an embodiment, the polymer may be present in the organic medium in the range of 8 wt. % to 11 wt. % of the medium. The silver thick film paste composition of the present invention may be adjusted to a predetermined, screen-printable viscosity with the organic medium.

In one embodiment, the ratio of organic medium in the silver thick film paste composition to the total amount of the electrically conductive silver powder, the one or more onium salts and the flux in the dispersion is dependent on the method of applying the paste and the kind of organic medium used, as determined by one of skill in the art. In an embodiment, the dispersion may include a total of 70-95 wt % of the electrically conductive silver powder, the one or more onium salts and the flux and 5-30 wt % of organic medium in order to obtain good wetting.

### Method of Making a Semiconductor Device

The invention also provides a method of making a semiconductor device, e.g., a solar cell or a photodiode. The semiconductor device has an electrode, e.g., a front side electrode of a solar cell or a photodiode, wherein prior to firing the electrode is comprised of a silver thick film paste composition of the invention shown as 500 in FIG. 1 and after firing shown as the electrode 501 in FIG. 1.

The method of manufacturing a semiconductor device, comprises the steps of:
(a) providing a semiconductor substrate, one or more insulating films, and the silver thick film paste composition of the invention;
(b) applying the insulating film to the semiconductor substrate,
(c) applying the silver thick film paste composition to the insulating film on the semiconductor substrate, and
(d) firing the semiconductor substrate, the insulating film and the silver thick film paste composition.

Exemplary semiconductor substrates useful in the methods and devices described herein include, but are not limited to, single-crystal silicon, multicrystalline silicon, and ribbon silicon. The semiconductor substrate may be doped with phosphorus and boron to form a p/n junction.

The semiconductor substrates can vary in size (length×width) and thickness. As an example, the thickness of the semiconductor substrate is 50 to 500 μm; 100 to 300 μm; or 140 to 200 μm. The length and width of the semiconductor substrate are each 100 to 250 mm; 125 to 200 mm; or 125 to 156 mm.

Typically, as discussed previously, an anti-reflection coating is formed on the front side of a solar cell. Exemplary anti-refection coating materials useful in the methods and devices described herein include, but are not limited to: silicon nitride, silicon oxide, titanium oxide, SiNₓ:H, hydrogenated amorphous silicon nitride, and silicon oxide/titanium oxide film. The coating can be formed by plasma enhanced chemical vapor deposition (PECVD), chemical vapor deposition (CVD), thermal CVD or other known techniques. In an embodiment in which the coating is silicon nitride, the silicon nitride film can be formed by low pressure CVD, PECVD, thermal CVD, or physical vapor deposition (PVD). In an embodiment in which the insulating film is silicon oxide, the silicon oxide film can be formed by thermal oxidation, thermal CVD, plasma CVD, or PVD.

The silver thick film paste composition of the invention can be applied to the anti-reflective coated semiconductor substrate by a variety of methods such as screen-printing, ink-jet printing, coextrusion, syringe dispensing, direct writing, and aerosol ink jet printing. The paste composition can be applied in a pattern and in a predetermined shape and at a predetermined position. In one embodiment, the paste composition is used to form both the conductive fingers and busbars of the front-side electrode. In such an embodiment, the width of the lines of the conductive fingers are 20 to 200 μm.

The paste composition coated on the ARC-coated semiconductor substrate can be dried, for example, for 0.5 to 10 minutes during which time the volatile solvents and organics of the organic medium are removed.

The dried paste is fired by heating to a maximum temperature of between 500 and 940° C. for a duration of 1 second to 2 minutes. In one embodiment, the maximum silicon wafer temperature reached during firing ranges from 650 to 800° C. for a duration of 1 to 10 seconds. In a further embodiment, the electrode formed from the silver thick film paste composition is fired in an atmosphere composed of a mixed gas of oxygen and nitrogen. In another embodiment, the electrode formed from the conductive thick film composition(s) is fired above the organic medium removal temperature in an inert atmosphere not containing oxygen. This firing process removes any remaining organic medium and sinters the flux with the silver powder to form an electrode. Typically, the burnout and firing is carried out in a belt furnace. The temperature range in the burnout zone, during which time the remaining organic medium is removed, is between 500 and 700° C. The temperature in the firing zone is between 860 and 940° C. The fired electrode can include components and compositions resulting from the firing and sintering process. For example, in an embodiment in which ZnO is a component in the paste composition, the fired electrode can include zinc-silicates, such as willemite (Zn₂SiO₄) and Zn_{1.7}SiO₄₋ₓ wherein x is 0-1.

During firing, the fired electrode, preferably the fingers, reacts with and penetrates the anti-reflective coating, e.g., a silicon nitride film, thereby making electrical contact with the silicon substrate. This fired-through state, i.e., the rextent to which the front electrode silver paste composition passes through the silver nitride film depends on the composition of the front electrode silver paste as well as the quality and thickness of the silver nitride film and the firing conditions. Conversion efficiency and moisture resistance reliability of the solar cell depend on this fired-through state. Efforts have been directed to develop a photovoltaic cell silver thick film paste composition that would more effectively penetrate the silicon nitride anti-reflection coating. It is believed that the improvement in solar cell performance in the presence of the iodonium salts in the instant composition is a result of the additional penetration they provide.

In a further embodiment, prior to firing, other conductive and device enhancing materials are applied to the back side of the semiconductor device and cofired or sequentially fired with the paste compositions of the invention. The materials serve as electrical contacts, passivating layers, and solderable tabbing areas.

In one embodiment, the back side conductive material contains aluminum or aluminum and silver.

### EXAMPLES

### Example 1

This Example describes the making of a silver thick film paste composition.

A mixture of 90 wt % DuPont™ Solamet® PV159 (a photovoltaic metallization paste comprising electrically conductive silver powder, glass frit, ZnO and an organic medium obtained from DuPont Microcircuit Materials, Research Triangle park, NC) and 10 wt % UVACURE® 1600 (phenyl-p-octyloxyphenyl-iodonium hexafluoroantimonate obtained from Cytec Industries, Smyrna, Ga.), Ciba® was mixed first by hand and then in a THINKY Mixer (THINKY USA, INC. Laguna Hills, Calif.) for 30 minutes. The resulting composition is a silver thick film paste composition containing a iodium salt.

DuPont™ Solamet® PV505 (a conductive silver composition obtained from DuPont Microcircuit Materials, Research Triangle park, NC) was screen printed to form back tab lines on 156 mm×156 mm 85Ω/□ monocrystalline silicon wafers (obtained from Gintech Energy Corp., Taiwan, R.O.C.). DuPont™ Solamet® PV381 (a conductive aluminum composition obtained from DuPont Microcircuit Materials, Research Triangle park, NC) was printed as a back cover of the wafers. These wafers contained a SiN_{X} anti-reflection coating on the front side.

The silver thick film paste composition containing a iodium salt formed above was screen printed onto the front side of the wafers using a 325 mesh, 23 wire, 25 μm emulsion screen with 100 μm grid line width.

Similarly, 156 mm×156 mm 65Ω/□ multicrystalline silicon wafers (obtained from Q-Cells SE, Bitterfeld-Wolfen, Germany) were printed with the same front side and back side electrodes. These wafers contained a silicon nitride anti-reflection coating on the front side.

Six pieces of wafers were printed using the monocrystalline silicon and six pieces of wafers were printed using the multicrystalline silicon. The printed wafers were fired in a Despatch 6-zone belt furnace with the zone temperatures of 500-550-610-700-880-900° C. and a belt speed of 220 ipm to produce solar cells with the front side electrodes formed from the silver thick film paste composition containing a iodium salt.

The solar cell was then placed in a Solar Cell Tester ST-1000 (TELECOM-STV Company Limited, Moscow, Russia) to measure I-V curves and determine the efficiency of the solar cell with the electrode made from the silver thick film paste composition. The xenon arc lamp of the I-V tester simulated sunlight with a known intensity and was used to irradiate the front side of the solar cell. The tester used a multi-point contact method to measure current (I) and voltage (V) to determine the cell's I-V curve. The efficiency was calculated from the I-V curve. The fill factor was calculated for the solar cells made with the monocrystalline wafer. The average of the six results for the 6 solar cells made with the monocrystalline wafer and the six results for the 6 solar cells made with the multicrystalline wafer are shown in Tables II and III, respectively.

### Example 2-5

### Comparative Experiment 1

Four more silver thick film paste compositions containing iodium salt were prepared using the procedure described in Example 1. The only differences were that in Examples 2-5, the amount of Solamet® PV159 was increased to 95 wt %, 97.5 wt %, 98 wt % and 98.5 wt % and the amount of UVACURE® 1600 was decreased to 5 wt %, 2.5 wt %, 2 wt % and 1.5 wt %, respectively. The silver thick film paste composition used in Comparative Experiment 1 was Solamet® PV159.

The amounts of Solamet® PV159 and UVACURE® in weight percent used in Examples 2-5 and Comparative Experiment 1 are shown in Table I

TABLE I

| | Ex- | Ex- | Ex- | Ex- | Ex- | Comparative |
|---|---|---|---|---|---|---|
| | ample | ample | ample | ample | ample | Experiment |
| | 1 | 2 | 3 | 4 | 5 | 1 |
| Solamet ® | 90 | 95 | 97.5 | 98 | 98.5 | 100 |
| PV159 | | | | | | |
| UVACURE ® | 10 | 5 | 2.5 | 2 | 1.5 | 0 |
| 1600 | | | | | | |

The silver thick film paste compositions of Examples 2-5 were used to form solar cells with the front side electrodes formed from the silver thick film paste composition containing iodium salt as described in Example 1. For each Example, six pieces of wafers were printed using the monocrystalline silicon and six pieces of wafers were printed using the multicrystalline silicon. The Solamet® PV159 silver thick film paste composition shown for Comparative Experiment 1 was also used to form solar cells for Comparative Experiment 1. Again, six pieces of wafers were printed using the monocrystalline silicon and six pieces of wafers were printed using the multicrystalline silicon.

The efficiencies and fill factors for the solar cells made with the monocrystalline wafers were determined for each solar cell. The average of the six results obtained for each of the Examples and Comparative Experiment 1 are shown in Table II.

TABLE II
Solar Cells Made With the Monocrystalline Wafers

| | | | | | | Comparative |
|---|---|---|---|---|---|---|
| | Example | Example | Example | Example | Example | Experiment |
| | 1 | 2 | 3 | 4 | 5 | 1 |
| Efficiency | 17.32 | 17.79 | 17.94 | 18.05 | 17.94 | 17.16 |
| Fill Factor | 73.85 | 74.98 | 75.76 | 76.14 | 75.67 | 73.41 |

The efficiencies of all the solar cells made with silver thick film paste compositions containing iodium salt were higher than that obtained in solar cells made with the silver thick film paste composition that did not contain iodium salt. The efficiency of Example 4 was improved by 0.89% over that of Comparative Experiment 1.

The efficiencies for the solar cells made with the multicrystalline wafers were determined for each solar cell. The average of the six results obtained for each of the Examples and Comparative Experiment 1 are shown in Table III.

TABLE III
Solar Cells Made With the Multicrystalline Wafers

| | | | | | | Comparative |
|---|---|---|---|---|---|---|
| | Example | Example | Example | Example | Example | Experiment |
| | 1 | 2 | 3 | 4 | 5 | 1 |
| Efficiency | 15.03 | 15.34 | 15.53 | 15.57 | 15.51 | 15.12 |

The efficiency of Example 4 was improved by 0.45% over that of Comparative Experiment 1.

What is claimed is:

1. A silver thick film paste composition comprising:
a) electrically conductive silver powder;
b) one or more onium salts selected from the group consisting of iodonium salts and sulfonium salts;
c) flux selected from the group consisting of glass frit, ZnO, Zn, compounds that can form ZnO upon firing and mixtures thereof; and
d) an organic medium,
wherein said silver powder, said one or more onium salts and said flux are dispersed in said organic medium.

2. The silver thick film paste composition of claim 1, wherein said iodonium salts are diaryl iodonium salts.

3. The silver thick film paste composition of claim 1, wherein said sulfonium salts are triaryl sulfonium salts.

4. The silver thick film paste composition of claim 1, wherein said flux is glass frit.

5. The silver thick film paste composition of claim 1, wherein said flux is ZnO.

6. The silver thick film paste composition of claim 1, wherein said flux is a mixture of glass frit and ZnO.

7. The silver thick film paste composition of claim 1, said composition comprising 0.5 to 15 wt % of said one or more onium salts, wherein said wt % is based on the total weight of said silver thick film paste composition.

8. The silver thick film paste composition of claim 7, said composition comprising 1 to 5 wt % of said one or more onium salts, wherein said wt % is based on the total weight of said silver thick film paste composition.

9. The silver thick film paste composition of claim 7, said composition comprising 1.5 to 2.5 wt % of said one or more onium salts, wherein said wt % is based on the total weight of said silver thick film paste composition.

10. The silver thick film paste composition of claim 7, said composition comprising a total of 70 to 95 wt % of said electrically conductive silver powder, said one or more onium salts and said flux and 5 to 30 wt % said organic medium, wherein said wt % is based on the total weight of said silver thick film paste composition.

11. The silver thick film paste composition of claim 10, wherein said flux is glass frit and said composition comprises 0.5 to 4 wt % said glass frit, wherein said wt % is based on the total weight of said silver thick film paste composition.

12. The silver thick film paste composition of claim 10, wherein said flux is ZnO and said composition comprises 2 to 10 wt % said ZnO, wherein said wt % is based on the total weight of said silver thick film paste composition.

13. The silver thick film paste composition of claim 10, wherein said flux is a mixture of glass frit and ZnO and said composition comprises 0.5 to 4 wt % said glass frit and 2 to 10 wt % said ZnO, wherein said wt % is based on the total weight of said silver thick film paste composition.

14. A semiconductor device comprising an electrode, wherein the electrode, prior to firing, comprises the silver thick film paste composition of any of claims 1-13.

15. A photovoltaic cell comprising an electrode, wherein the electrode, prior to firing, comprises the silver thick film paste composition of any of claims 1-13.
